(19) United States
(12) Patent Application Publication
(10) Pub. No.: US 2010/0192850 A1
(43) Pub. Date: Aug. 5, 2010

(54) COATING LIQUID STORAGE TANK AND MICRO GRAVURE COATING DEVICE HAVING THE SAME

(75) Inventors: Sung-Jin Kim, Suwon-si (KR); Jee-Sang Hwang, Suwon-si (KR); Ho-Seob Lee, Suwon-si (KR); Su-Hwan Kim, Suwon-si (KR)

Correspondence Address: STEIN MCEWEN, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/700,014

(22) Filed: Feb. 4, 2010

(30) Foreign Application Priority Data
Feb. 5, 2009 (KR) 10-2009-0009343

(51) Int. Cl. B05C 11/10; B05C 1/08

(52) U.S. Cl. 118/610; 118/258

(57) ABSTRACT

A coating liquid storage tank and a micro gravure coating device having the same, the coating liquid storage tank including: a supply port to supply a coating liquid; a discharge port provided at a bottom of the storage tank to discharge the coating liquid; and a buffer plate provided above the discharge port to allow foreign substance in the supplied coating liquid to pass to the discharge port and to block waves in the supplied coating liquid from the bottom of the storage tank. In addition, the micro gravure coating device includes the coating liquid storage tank, and a micro gravure roll provided at an upper portion of the coating liquid storage tank and at least partially submerged in the coating liquid. Therefore, it is possible to effectively prevent floating matters from being coated on a substrate.

### CROSS-REFERENCE TO RELATED APPLICATION

This application claims the benefit of Korean Application No. 10-2009-0009343, filed Feb. 5, 2009 in the Korean Intellectual Property Office, the disclosure of which is incorporated herein by reference.

### BACKGROUND OF THE INVENTION

1. Field of the Invention

Aspects of the present invention relate to a coating liquid storage tank and a micro gravure coating device having the same, and more particularly, to a coating liquid storage tank and a micro gravure coating device having the same to effectively prevent floating foreign substances from being coated on a substrate.

2. Description of the Related Art

Because secondary batteries can be continuously used through repeated charging and discharging, secondary batteries are more economical than disposable batteries. Recently, because the secondary batteries have been able to provide a large capacity at a small volume, they have been widely used as drive powers of mobile electronics and electric appliances (such as mobile phones, camcorders, notebook computers, etc). Such secondary batteries include nickel-cadmium batteries, nickel-metal hydride batteries, nickel-zinc batteries, lithium secondary batteries, etc.

Among these, the lithium secondary batteries are most widely used, because of a possibility of miniaturization and large capacity, a high operation voltage, a high energy density per unit weight, etc. The lithium secondary batteries may be classified into a can-type battery and a pouch-type battery according to a shape of an outer case housing an electrode assembly including a positive electrode plate, a negative electrode plate, and a separator. In addition, the can-type may be classified as a cylinder type battery or a prismatic type battery.

The positive electrode plate includes positive electrode active materials applied on a positive electrode collector, and the negative electrode plate includes negative electrode active materials applied on a negative electrode collector. Here, in order to increase safety of the positive electrode plate and the negative electrode plate, functional films may be coated on the plates by a micro gravure coating device using a micro gravure roll.

FIG. 1 is a schematic cross-sectional view of a conventional micro gravure coating device. Referring to FIG. 1, the conventional micro gravure coating device includes a gravure roll 20 rotatably provided at an upper center portion of a storage tank 30 storing a coating liquid. The gravure roll 20 can be rotated clockwise as shown in FIG. 1, or may be rotated counterclockwise.

First and second guide rolls 11 and 12 are installed over the gravure roll 20 to guide a movement of a substrate 10 to be coated (for example, the positive or negative electrode plate). The first and second guide rolls 11 and 12 can be rotated counterclockwise as shown in FIG. 1, or may be rotated clockwise.

In addition, a supply port 31 is provided at a side of the storage tank 30 to supply coating materials (for example, positive electrode active materials or negative electrode active materials) into the storage tank 30. Furthermore, a discharge port 32 is provided at the bottom of the storage tank 30 to discharge the coating liquid from the storage tank 30. Here, an opening/closing member 33 is located at the discharge port 32 to open and close the discharge port 32, and a discharge passage 34 extends from the discharge port 32 to convey the coating liquid discharged from the discharge port 32.

That is, the coating liquid supplied through the supply port 31 is coated on a substrate through the gravure roll 20, and the discharge opening/closing member 33 is opened to discharge the coating liquid (for example, upon completion of the coating of the substrate through the gravure roll 20).

At this time, floating matters 40 may be contained in the coating liquid. As a result, the substrate may be coated with the coating liquid and the floating matters leading to inferior coating and an inferior product. In addition, during the process of coating the coating liquid on the substrate, the coating liquid is continuously supplied through the supply port 31. Waves generated by the supply of the coating liquid and rotation of the gravure roll 20 cause the matters 40 settled on the bottom of the storage tank to float again, further causing inferior coating and an inferior product.

### SUMMARY OF THE INVENTION

Aspects of the present invention provide a coating liquid storage tank and a gravure coating device having the same to effectively prevent foreign substances from being coated on a substrate.

According to an aspect of the present invention, there is provided a coating liquid storage tank including: a supply port to supply a coating liquid; a discharge port provided at a bottom of the storage tank to discharge the coating liquid; and a buffer plate provided above the discharge port.

According to another aspect of the present invention, there is provided a micro gravure coating device including: a coating liquid storage tank including: a supply port to supply a coating liquid, a discharge port provided at a bottom of the storage tank to discharge the coating liquid, and a buffer plate provided above the discharge port; and a micro gravure roll provided at an upper portion of the coating liquid storage tank.

The buffer plate may include a blocking portion to block the waves, and an opening to allow the foreign substances to pas to the discharge port, and the blocking portion may have a slope.

The buffer plate may further include magnets provided at both ends thereof.

A bottom surface of the storage tank may have a slope, and the discharge port may be provided at a lowest portion of the slope.

The coating liquid storage tank may further include an overflow port provided at a predetermined location of the storage tank corresponding to the supply port, the overflow port discharging foreign substances in the supplied coating liquid during a coating process.

The discharge port may be connected to a discharge passage to discharge the foreign substances to an exterior of the storage tank, and the overflow port may be connected to an overflow port discharge passage that may be connected to the discharge passage of the discharge port.

The overflow port may be provided at a predetermined height of the storage tank to maintain a uniform level of the coating liquid at the predetermined height.

The coating liquid storage tank may further include first and second partition walls positioned near the supply port.

The first partition wall may be fixed to a bottom surface of the storage tank, and the second partition wall may be fixed to a side wall of the storage tank.

The first partition wall may be provided perpendicular to a supply direction of the coating liquid, and the second partition wall may be inclined with respect to the supply direction of the coating liquid.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawing of which:

FIG. 1 is a schematic cross-sectional view of a conventional micro gravure coating device;

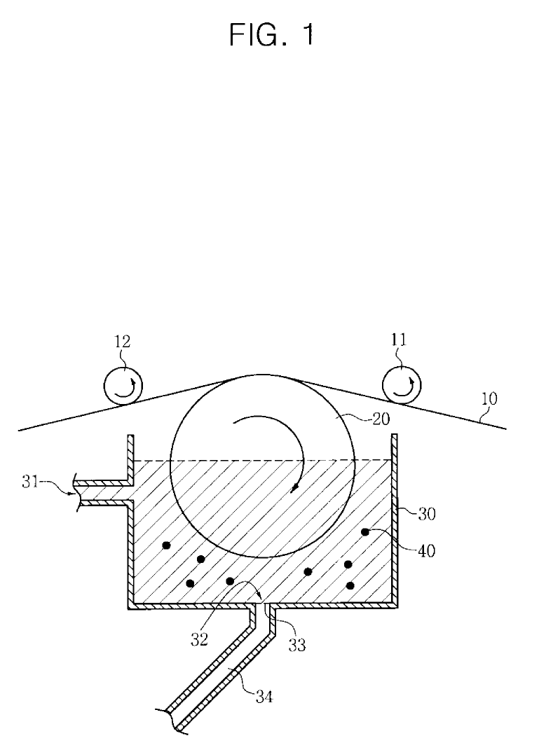

FIG. 2 is a schematic cross-sectional view of a micro gravure coating device having a coating liquid storage tank according to an embodiment of the present invention; and

FIG. 3 is a perspective view of a buffer plate according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

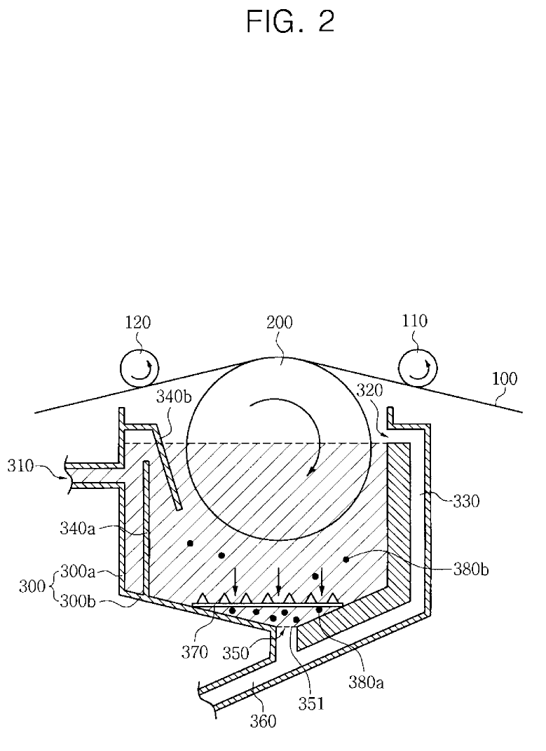

FIG. 2 is a schematic cross-sectional view of a micro gravure coating device having a coating liquid storage tank according to an embodiment of the present invention. Referring to FIG. 2, the micro gravure coating device includes a gravure roll 200 rotatably provided at a certain region of an upper portion of a storage tank 300 in which a coating liquid is stored. The gravure roll 200 can be rotated clockwise as shown in FIG. 2, or may be rotated counterclockwise.

First and second guide rolls 110 and 120 are provided over the gravure roll 200 to guide a movement of a substrate 100 to be coated (for example, a positive electrode plate or a negative electrode plate). The first and second guide rolls 110 and 120 can be rotated counterclockwise as shown in FIG. 2, or may be rotated clockwise.

In addition, a supply port 310 is provided at a side of the storage tank 300 to supply coating materials (for example, positive electrode active materials or negative electrode active materials) into the storage tank 300, and a discharge port 350 is provided at a discharge side of the storage tank 300 (in the present embodiment, the bottom of the storage tank 300) to discharge the coating liquid from the storage tank 300. While not shown, the supply port 310 may be installed at a right side of the storage tank 300, though aspects of the present invention are not limited thereto. Here, an opening/closing member 351 is located at the discharge port 350 to open and close the discharge port 350, and a discharge passage 360 extends from the discharge port 350 to convey the coating liquid discharged from the discharge port 350.

Hereinafter, the coating liquid storage tank 300 according to an embodiment of the present invention will be described. The coating liquid storage tank 300 includes a wall portion 300a having no slope, a bottom 300b having a slope, and a discharge port 350 formed at a low slope of the bottom 300b. By providing the slope at the bottom 300b of the storage tank 300, foreign substances settled along the slope can readily arrive at a low point of the slope (i.e., the discharge port 350). That is, when the floating matters 380b are settled, the settled matters 380a can readily arrive at the discharge port 350 along the slope of the bottom 300b.

Therefore, during the process of coating the coating liquid on the substrate 100, the settled matters 380a are accumulated around the discharge port 350. Accordingly, when an opening and closing component 351 of the discharge port is opened, the settled matter 380a with the coating liquid is discharged through a discharge passage of the discharge port 350.

Here, a buffer plate 370 is provided over the discharge port 350. As will be described below, the buffer plate 370 includes openings so that the floating matters 380b settle and then pass through the buffer plate 370 to arrive at the discharge port 350. That is, when the matters 380b floating in the coating liquid settle, the settled matters 380a arrive at the bottom of the storage tank 300 through the openings of the buffer plate 370. In addition, the bottom of the storage tank 300 has a slope so that the settled matters 380a can readily arrive at the discharge port 350.

In the conventional gravure coating device, coating liquid is continuously supplied through the supply port during the process of coating the coating liquid on the substrate. At this time, waves generated due to supply of the coating liquid and rotation of the gravure roll cause the matters settled on the bottom of the storage tank to float again, causing inferior coating and an inferior product. However, according to aspects of the present invention, the buffer plate 370 blocks waves generated by supply of the coating liquid and rotation of the gravure roll 200 to prevent the waves from arriving at the bottom of the storage tank 300. As a result, the settled matters 380a do not float again. In addition, even when a small amount of settled matters 380a float, the buffer plate 370 acts as a blocking layer to prevent the settled matters 380a from floating significantly.

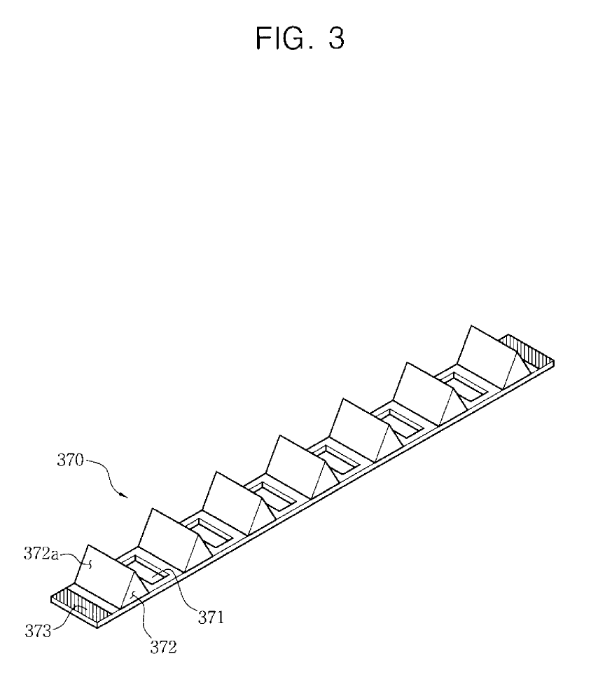

FIG. 3 is a perspective view of a buffer plate 370 according to an embodiment of the present invention. Referring to FIG. 3, the buffer plate 370 includes blocking portions 372 having a triangular pole shape, and openings 371. Each blocking portion 372 has a slope 372a. Here, the blocking portion is a region through which the matters 380b cannot pass, and the opening is a region through which the matters 380b can pass.

That is, in order to readily move the matters 380b to the bottom of the storage tank 300 through the openings 371, the blocking portions 372 have slopes 372a so that the matters 380b move along the slopes 372a. As a result, most of the matters 380b settle through the openings 371, without stopping on the blocking portion 372. In addition, magnets 373 are provided at both ends of the buffer plate 370 to readily separate or install the buffer plate 370 from/at the storage tank 300, though it is understood that aspects of the present invention are not limited thereto. That is, according to other aspects, other connecting devices may be used (such as latches, plugs, etc.) or no connecting devices may be used.

Referring back to FIG. 2, the coating liquid storage tank 300 further includes an overflow port 320 at a certain region corresponding to the supply port 310. Here, the overflow port 320 is positioned at the same height as a level at which the coating liquid is to be maintained.

The overflow port 320 operates to discharge the floating matters 380b existing in the coating liquid during a process of coating the coating liquid on the substrate 100, and uniformly maintains the level of the coating liquid so that the micro gravure roll 200 is uniformly submerged in the coating liquid at a certain level. In contrast, the conventional gravure coating device only includes the discharge port, and thus, it is impossible to remove the floating matters existing in the coating liquid during the process of coating the coating liquid on the substrate. In addition, while it is difficult to adjust a certain level of the coating liquid supplied from the supply port, the micro gravure coating device according to an embodiment of the present invention includes the overflow port 320 in the storage tank 300 to make it possible to discharge the floating matters 380b even during the process of coating the coating liquid on the substrate 100 and readily maintains the level of the coating liquid. As shown, the overflow port 320 is connected to an overflow port discharge passage 330, which may be connected to a discharge passage 360 of the discharge port 350.

Furthermore, the coating liquid storage tank 300 also includes first and second partition walls 340a and 340b provided near the supply port 310. The first partition wall 340a is fixed to the bottom 300b of the storage tank 300, and the second partition wall 340b is fixed to the wall 300a of the storage tank 300, though it is understood that the fixing positions of the first and second partition walls 340a and 340b are not limited thereto in all aspects of the present invention.

When the electrode plates are coated through the micro gravure coating device, pinholes are generated, causing stains on a coating pattern. In order to minimize movement of the coating liquid upon supply thereof and prevent generation of the stains, the partition walls 340a and 340b are provided near the supply port 310. The first partition wall 340a is provided perpendicularly to a supply direction of the coating liquid to minimize the movement of the coating liquid, and the second partition wall 340b is inclined to form an angle (for example, an angle of about 45° with respect to the supply direction of the coating liquid to also reduce the movement of the coating liquid, minimized by the first partition wall 340a. That is, by minimizing the movement upon supply of the coating liquid, it is possible to prevent generation of stains on the coating pattern. In addition, by minimizing the movement of the coating liquid in the storage tank 300, it is possible to reduce a floatation of the settled matters 380a.

As can be seen from the foregoing, aspects of the present invention provide a coating liquid storage tank 300 and a gravure coating device having the same that effectively prevent floating matters 380b from being coated on a substrate 100. In addition, a buffer plate 370 is provided on the discharge port 350 of the storage tank 300 to prevent generation of waves due to supply of the coating liquid and rotation of the gravure roll 200 and prevent the settled matters 380a from floating. Moreover, the bottom of the storage tank 300 has a slope, and a discharge port 350 is provided at a low point of the slope so that the settled matters 380a can easily arrive at the discharge port 350. Furthermore, an overflow port 320 is located at a certain region of the storage tank 300 so that the floating matters 380b can be discharged even during the coating process and the level of the coating liquid can be readily maintained. In addition, one or more partition walls 340a and 340b are provided near a coating liquid supply port 310 to minimize movement of the coating liquid upon supply thereof. Though aspects of the present invention have been described to provide a coating liquid storage tank 300 including a sloped bottom, a buffer plate 370, an overflow port 320, and one or more partition walls 340a and 340b, it is understood that aspect are not limited thereto. That is, according to other aspects, the storage tank 300 could include only one of the sloped bottom, the buffer plate 370, the overflow port 320, and the one or more partition walls 340a and 340b, or any combination thereof. For example, the storage tank 300 could include the overflow port 320 and the one or more partition walls 340a and 340b, without the sloped bottom or the buffer plate 370.

Although a few embodiments of the present invention have been shown and described, it will be appreciated by those skilled in the art that changes may be made in this embodiment without departing from the principles and spirit of the invention, the scope of which is defined in the claims and their equivalents.

What is claimed is:

1. A coating liquid storage tank comprising:
a supply port to supply a coating liquid;
a discharge port provided at a bottom of the storage tank to discharge the coating liquid; and
a buffer plate provided above the discharge port.

2. The coating liquid storage tank as claimed in claim 1, wherein the buffer plate comprises a blocking portion to block the waves, and an opening to allow the foreign substances to pass to the discharge port, and the blocking portion has a slope.

3. The coating liquid storage tank as claimed in claim 1, wherein the buffer plate further comprises magnets provided at both ends thereof.

4. The coating liquid storage tank as claimed in claim 1, wherein a bottom surface of the storage tank has a slope, and the discharge port is provided at a lowest portion of the slope.

5. The coating liquid storage tank as claimed in claim 1, further comprising an overflow port provided at a predetermined location of the storage tank corresponding to the supply port, the overflow port discharging foreign substances in the supplied coating liquid during a coating process.

6. The coating liquid storage tank as claimed in claim 5, wherein:
the discharge port is connected to a discharge passage to discharge the foreign substances to an exterior of the storage tank; and
the overflow port is connected to an overflow port discharge passage that is connected to the discharge passage.

7. The coating liquid storage tank as claimed in claim 5, wherein the overflow port is provided at a predetermined height of the storage tank to maintain a uniform level of the coating liquid at the predetermined height.

8. The coating liquid storage tank as claimed in claim 1, further comprising one or more partition walls positioned near the supply port to minimize a movement of the coating liquid when supplied from the supply port.

9. The coating liquid storage tank as claimed in claim 8, wherein the one or more partition walls comprise a first partition wall fixed to a bottom surface of the storage tank, and a second partition wall fixed to a side wall of the storage tank.

10. The coating liquid storage tank as claimed in claim 8, wherein the one or more partition walls comprise a first partition wall provided perpendicular to a supply direction of the coating liquid, and a second partition wall inclined with respect to the supply direction of the coating liquid.

11. A micro gravure coating device comprising:
a coating liquid storage tank comprising:
a supply port to supply a coating liquid,
a discharge port provided at a bottom of the storage tank to discharge the coating liquid, and
a buffer plate provided above the discharge port; and
a micro gravure roll provided at an upper portion of the coating liquid storage tank.

12. The micro gravure coating device as claimed in claim 11, wherein the buffer plate comprises a blocking portion to block the waves, and an opening to allow the foreign substances to pass to the discharge port, and the blocking portion has a slope.

13. The micro gravure coating device as claimed in claim 11, wherein the buffer plate further comprises magnets provided at both ends thereof.

14. The micro gravure coating device as claimed in claim 11, wherein a bottom surface of the storage tank has a slope, and the discharge port is provided at a lowest portion of the slope.

15. The micro gravure coating device as claimed in claim 11, wherein the coating liquid storage tank further comprises an overflow port provided at a predetermined location of the storage tank corresponding to the supply port, the overflow port discharging foreign substances in the supplied coating liquid during a coating process.

16. The micro gravure coating device as claimed in claim 15, wherein:
the discharge port is connected to a discharge passage to discharge the foreign substances to an exterior of the storage tank; and
the overflow port is connected to an overflow port discharge passage that is connected to the discharge passage.

17. The micro gravure coating device as claimed in claim 15, wherein the overflow port is provided at a predetermined height of the storage tank to maintain a uniform level of the coating liquid at the predetermined height.

18. The micro gravure coating device as claimed in claim 11, wherein the coating liquid storage tank further comprises one or more partition walls positioned near the supply port to minimize a movement of the coating liquid when supplied from the supply port.

19. The micro gravure coating device as claimed in claim 18, wherein the one or more partition walls comprise a first partition wall fixed to a bottom surface of the storage tank, and a second partition wall fixed to a side wall of the storage tank.

20. The micro gravure coating device as claimed in claim 18, wherein the one or more partition walls comprise a first partition wall provided perpendicular to a supply direction of the coating liquid, and a second partition wall inclined with respect to the supply direction of the coating liquid.
